(19) United States
(12) Patent Application Publication
(10) Pub. No.: US 2005/0260318 A1
(43) Pub. Date: Nov. 24, 2005

(54) Process for improver premix for chapatis and related products

(75) Inventors: Ragu Sai Manohar, Karnataka (IN); Gandham Venkateswara Rao, Karnataka (IN)

Correspondence Address: FOLEY AND LARDNER;SUITE 500, 3000 K STREET NW, WASHINGTON, DC, 20007, US

(73) Assignee: COUNCIL OF SCIENTIFIC AND INDUSTRIAL RESEARCH

(21) Appl. No.: 10/402,258

(22) Filed: Mar. 31, 2003

(51) Int. Cl. A21D 10/00

(52) U.S. Cl. 426/549

(57) ABSTRACT

A process for preparing an improved quality chapatis having novel improver premix providing longer shelf-life to the chapatis, said process comprising steps of mixing an improver mix of concentration ranging between comprising of ascorbic acid, sodium stearoyl lactylate and guar gum with whole wheat flour, adding sufficient quantity of water to the mixture of step (a) and mixing the same to obtain chapati dough, ageing the chapati dough for a time period in the range of 20 to 30 minutes, and sheeting and baking the aged chapati dough to obtain the chapatis; also, an improver premix comprising ascorbic acid, sodium stearoyl lactylate, and guar gum useful for the preparation of chapati, and further, a chapati comprising of whole-wheat flour, improver premix, water, total dry matter, moisture in chapati.

### FIELD OF THE PRESENT INVENTION

A process for preparing an improved quality chapatis having novel improver premix providing longer shelf-life to the chapatis, said process comprising steps of mixing an improver mix of concentration ranging between comprising of ascorbic acid, sodium stearoyl lactylate and guar gum with whole wheat flour, adding sufficient quantity of water to the mixture of step (a) and mixing the same to obtain chapati dough, ageing the chapati dough for a time period in the range of 20 to 30 minutes, and sheeting and baking the aged chapati dough to obtain the chapatis; also, an improver premix comprising ascorbic acid, sodium stearoyl lactylate, and guar gum useful for the preparation of chapati, and further, a chapati comprising of whole-wheat flour, improver premix, water, total dry matter, moisture in chapati.

### BACKGROUND AND PRIOR ART REFERENCES

The chapati is a flat unleavened baked product, which forms the staple food of the majority of the population in the Indian subcontinent and parts of the Middle East. The consumption of this traditional product is increasing and has become popular even in areas where traditionally rice has been the staple diet. Chapatis are normally made and served hot at breakfast, lunch or dinner, and are eaten along with other adjuncts in households, restaurants and industrial canteens. There are several culinary variations of the chapati—the important ones being the parotha, stuffed parotha, tandoori roti, phulka and puri. The other culinary variations come under the category of unfermented flat breads; they are dense in texture, comprising mostly crust with little or no crumb. The texture should be soft, smooth and pliable, and these characteristics should be retained for at least 2-3 hrs of storage. The very short keeping quality of chapatis poses serious problems where they have to be served to a large number of consumers at one time, as in industrial canteens or in restaurants. The chapati is an intermediate moisture product, containing 25-35% moisture, stales like bread or cake, becoming less acceptable on storage. Storage tends to make chapati hard and brittle. In addition to these changes, mold growth also occurs after 3-4 days of storage.

The information on the use of additives in chapati and related products is scanty. Chapatis with yeast leavening, glycerol monostearate, and alpha amylase supplements notably improved the texture and flavour of whole meal chapaties as compared with traditional unleavened chapaties, which are tough and highly susceptible to staling (Swaranjeet, K., Maninder, K., and Bains, G. S. 1982. Chapaties with leavening and supplements; changes in texture, residual sugars, and phytic phosphorous. Cereal Chemistry, 59, 367-372). Sucrose-ester emulsifiers did not improve dough handling characteristics or tenderness of the finished product (Ebeler, S. E., and Walker, C. E. 1983. Wheat and composite flour chapaties; Effect of soy flour and sucrose-ester emulsifiers. Cereal Chemistry, 60, 270-275). Addition of salt (1.25%), glycerol monostearate (0.5%), sorbic acid (0.2%) and fat (4%) minimized development of brittleness to some extent (Venkateswara Rao, G., Leelavathi, K., Haridas Rao, P. and Shurpalekar, S. R. 1986. Changes in the quality characteristics of chapati during storage. Cereal Chemistry. 63, 131-135). Incorporation of emulsifiers such as glycerol monostearate, sucrose esters and sodium stearoyl lactylate and alpha amylase improved the texture of chapati as well as keeping quality (Haridas Rao, P. 1993. Chapati and related products. In: Encyclopedia on Food Science Technology and Nutrition, Academic press. 795-801). Texture of chapatis was improved by yeast fermentation with or without lactic acid. Addition of lactic acid softened chapatis more than addition of yeast (Syed, H. M., Rathi, S. D., and Sawate, A. R. 1991. Studies on improving chapati quality. Indian Miller. 22, 26-31). Addition of 0.10-0.20% ascorbic acid improved the texture and puffing of chapatis made from atta (Abrol, Y. P., Mehd, V., Uprety, D. C., Tikoo, S., and Ram. A. 1972. Studies on chapati quality III. Preservation of discoloration of chaptis. Bulletin of Grain technology. 10, 100-106).

Sorbic acid is normally used as an antifungal agent for preserving chapati. The maximum level that could be incorporated with out affecting the taste is 0.1%. The mold growth is delayed by 2-3 days at this level. However, use of higher level of sorbic acid (0.3%) along with 1.5% salt, and packaging in polythene (200 gauge), or in an aluminium foil/polyethylene laminate, can delay mold growth for as long as 180 days. The level of sorbic acid could be reduced further either by including 0.4% citric acid, 3% sugar and 2.5% salt in recipe, or by heating the packed chapatis made for defence personnel are preserved by in-pack heat sterilization after being packed in paper/foil/poly laminate. Packed chapattis/parothas exposing to (gamma) radiation of 1 M radiation also delay mould growth for 180 days. (Arya SS, Vidyasagar K and Parihar DB, 1977, preservation of chapati. Lebensmittel-wissenschaft and Technology, 10:208).

Reference may be made to Kameswara Rao G, malathi M. A, Mohan, M. S, 1970.

Preservation and packaging of Indian Foods III parottas, Journal of Food Science and Technology 6, 279 where in parothas were preserved using sorbic acid and salt, and packing in cellophane pouch and repacking in paper/foil/polyethylene pouches. The drawback is that the parothas contained as high as 1.25% salt and 0.3% sorbic acid.

Reference may be made to Bhatia B. S. and Nath H, 1971. Some technological aspects of Defence Food Research in India during the sixties. Indian food packer 25; 59 where in preservation of chapatis and parothas were achieved using sorbic acid and salt or by irradiation or by heat processing in high vacuum covers. The draw back is that the chapatis contained high levels of salt and sorbic acid.

Reference may be made to Arya S. S, Vidyasagar K, Parihar, D. B, 1977. Preservation of chapatis. Lebensmittel-Wissenschaft und-technology 10, 208, where in chapatis were preserved using citric acid, sorbic acid, salt and sugar. The effective concentration of sorbic acid can be reduced to 0.15% by in pack heating of chapatis for 2 hrs at 90-95° C. Incorporation of fat, dried milk and oleoresins of cumin seeds and cardamom have been tried to improve the texture and flavour of preserved chapatis. The draw back is that the chapatis contained high amount of salt, citric acid and sorbic acid and the taste of chapati is very much affected.

Reference may be made to Mohan Chandra, Rajale Gopinath Babasheb, Venkataramana Ancha, Banerjee Rinka, Kapur Gunender, Van Buren Lex, and Smorenburg Herbert. Patent No. WOO 182722 (2001) where in cereal grains and flour and particular to a synergistic mix of flour and flour obtained from high temperature treated cereal grains suitable for use in flat breads such as chapati making is described.

The draw back is that heated flour other than wheat grain are used.

Production of improved cereal grain or cereal flour Patent Number WO0182722

Requested Patent WO182722A 1

Application number WO2001EP00741 20010119

Automatic chapatti maker Patent Number IN 156618

Chapatti Making Machine

Patent Number: U.S. Pat. No. 4,806,090

PAT. NO. Title

1 U.S. Pat. No. 6,217,442 Grain processing apparatus and methods
2 U.S. Pat. No. 6,117,472 Process for preparing dough pieces
3 U.S. Pat. No. 6,098,905 Method for producing an atta flour
4 U.S. Pat. No. 5,996,476 Device for pressing, imprinting and cooking flat bread products
5 U.S. Pat. No. 5,630,358 Countertop appliance for making disc-shaped edibles
6 U.S. Pat. No. 5,546,850 Electric rolling pin apparatus for making discs of dough
7 U.S. Pat. No. 5,501,141 Tortilla warming apparatus
8 U.S. Pat. No. 5,281,427 Process for producing pastry products
9 U.S. Pat. No. 4,857,349 Apparatus for rolling circular dough product
10 U.S. Pat. No. 4,806,090 Chapati making machine
11 U.S. Pat. No. 4,683,813 Synchronized press for bakery products

### OBJECTS OF THE PRESENT INVENTION

The main objective of the present invention is to provide an improver premix for improved quality chapatis.

Yet another objective is to provide a process for modifying dough characteristics suitable for chapatti making.

Still another object of the present invention is to develop a chapati comprising the novel premix.

### SUMMARY OF THE PRESENT INVENTION

A process for preparing an improved quality chapatis having novel improver premix providing longer shelf-life to the chapatis, said process comprising steps of mixing an improver mix of concentration ranging between comprising of ascorbic acid, sodium stearoyl lactylate and guar gum with whole wheat flour, adding sufficient quantity of water to the mixture of step (a) and mixing the same to obtain chapati dough, ageing the chapati dough for a time period in the range of 20 to 30 minutes, and sheeting and baking the aged chapati dough to obtain the chapatis; also, an improver premix comprising ascorbic acid, sodium stearoyl lactylate, and guar gum useful for the preparation of chapati, and further, a chapati comprising of whole-wheat flour, improver premix, water, total dry matter, moisture in chapati.

### DETAILED DESCRIPTION OF THE PRESENT INVENTION

A process for preparing an improved quality chapatis having novel improver premix providing longer shelf-life to the chapatis, said process comprising steps of mixing an improver mix of concentration ranging between comprising of ascorbic acid, sodium stearoyl lactylate and guar gum with whole wheat flour, adding sufficient quantity of water to the mixture of step (a) and mixing the same to obtain chapati dough, ageing the chapati dough for a time period in the range of 20 to 30 minutes, and sheeting and baking the aged chapati dough to obtain the chapatis; also, an improver premix comprising ascorbic acid, sodium stearoyl lactylate, and guar gum useful for the preparation of chapati, and further, a chapati comprising of whole-wheat flour, improver premix, water, total dry matter, moisture in chapati.

In an embodiment of the present invention, wherein a process for preparing an improved quality chapatis having novel improver premix providing longer shelf-life to the chapatis, said process comprising steps of:
mixing an improver mix of concentration ranging between comprising of ascorbic acid, sodium stearoyl lactylate and guar gum with whole wheat flour,
adding sufficient quantity of water to the mixture of step (a) and mixing the same to obtain chapati dough,
ageing the chapati dough for a time period in the range of 20 to 30 minutes, and
sheeting and baking the aged chapati dough to obtain the chapatis.

In another embodiment of the present invention, wherein the whole wheat flour comprises total ash of concentration ranging between 1.6-1.8%, proteins of concentration ranging between 5 to 10%, Ether extractable fat of concentration ranging between 1.02-3.0%, and damaged starch of concentration ranging between 15-20%.

In yet another embodiment of the present invention, wherein an improver premix comprising ascorbic acid, sodium stearoyl lactylate, and guar gum.

In still another embodiment of the present invention, wherein the ratio of ascorbic acid to sodium stearoyl lactylate is ranging between 1:5 to 1:7.

In still another embodiment of the present invention, wherein the ratio of ascorbic acid to guar gum is ranging between 1:5 to 1:7.

In still another embodiment of the present invention, wherein the ratio of whole-wheat flour and improver premix is ranging between 60:1 to 220:1.

In still another embodiment of the present invention, wherein the ratio of guar gum to sodium stearoyl lactylate is ranging between 1:2 to 2:1.

In still another embodiment of the present invention, wherein 10-60 parts of water is added to the mixture of whole-wheat flour and improver mix.

In still another embodiment of the present invention, wherein the aged chapati dough is sheeted to a thickness of about 1.25-2.0 cm and optionally cut into circles of diameter 14.0-16.0 cm.

In still another embodiment of the present invention, wherein the sheeted chapati dough is baked at temperature ranging between about 210 to 230° C. for a time period of about 45-90 seconds.

In still another embodiment of the present invention, wherein the sheeted chapati is baked on either side.

In still another embodiment of the present invention, wherein the baked chapati is optionally puffed at a temperature ranging between about 290-310° C. for a time period of about 15-20 seconds.

In still another embodiment of the present invention, wherein an improver premix comprising ascorbic acid, sodium stearoyl lactylate, and guar gum.

In still another embodiment of the present invention, wherein the ratio of ascorbic acid to sodium stearoyl lactylate is ranging between 1:5 to 1:7.

In still another embodiment of the present invention, wherein the ratio of ascorbic acid to guar gum is ranging between 1:5 to 1:7.

In still another embodiment of the present invention, wherein the ratio of guar gum to sodium stearoyl lactylate is ranging between 1:2 to 2:1.

In still another embodiment of the present invention, wherein water absorption increases with the increase in the concentration of the improver premix.

In still another embodiment of the present invention, wherein dough development time increases by about 30% with the use of improver premix.

In still another embodiment of the present invention, wherein stability increases by about 85% with the use of improver premix.

In still another embodiment of the present invention, wherein quality number increases by about 55% with the use of improver premix.

In still another embodiment of the present invention, wherein extensibility increases by about 12% with the use of improver premix.

In still another embodiment of the present invention, wherein tearing strength increases by about 30% with the use of improver premix.

In still another embodiment of the present invention, wherein aroma increases by about 20% with the use of improver premix.

In still another embodiment of the present invention, wherein eating quality increases by about 27% with the use of improver premix.

In still another embodiment of the present invention, wherein overall quality increases by about 20% with the use of improver premix.

In still another embodiment of the present invention, wherein a chapati comprising of whole-wheat flour, improver premix, water, total dry matter, moisture in chapati.

In still another embodiment of the present invention, wherein increase in ascorbic acid reduces pliability and eating quality of chapati.

In still another embodiment of the present invention, wherein chapati becomes more chewy with the increase with the concentration of ascorbic acid.

In still another embodiment of the present invention, wherein water absorption increases with the increase in the concentration of the improver premix.

In still another embodiment of the present invention, wherein dough development time increases by about 30% with the use of improver premix.

In still another embodiment of the present invention, wherein stability increases by about 85% with the use of improver premix.

In still another embodiment of the present invention, wherein quality number increases by about 55% with the use of improver premix.

In still another embodiment of the present invention, wherein extensibility increases by about 12% with the use of improver premix.

In still another embodiment of the present invention, wherein tearing strength increases by about 30% with the use of improver premix.

In still another embodiment of the present invention, wherein aroma increases by about 20% with the use of improver premix.

In still another embodiment of the present invention, wherein eating quality increases by about 27% with the use of improver premix.

In still another embodiment of the present invention, wherein overall quality increases by about 20% with the use of improver premix.

In still another embodiment of the present invention, wherein the storage period of the chapati with good quality nutrients is about 24 hours.

In still another embodiment of the present invention, wherein the ratio of ascorbic acid to sodium stearoyl lactylate is ranging between 1:5 to 1:7.

In still another embodiment of the present invention, wherein the ratio of ascorbic acid to guar gum is ranging between 1:5 to 1:7.

In still another embodiment of the present invention, wherein the ratio of guar gum to sodium stearoyl lactylate is ranging between 1:2 to 2:1.

Chapatis are prepared with whole-wheat flour and water. This invention relates to a process for improver premix for chapatis and related products.

Accordingly the present invention provides an important process for improver premix for chapatis and related products which comprises
i. Premix composition for preparation of improved chapati quality
ii. Mixing of whole wheat flour, improver premix and water for a time period of 4-8 min
iii. Resting of dough for a time period of 15-45 min
iv. Sheeting and cutting of dough for a diameter of 14-16 cm and thickness of 1.25 to 2.0 mm
v. Baking of chapatti dough sheet for a temperature of 200-240° C. time period of 60-90 sec on either side
vi. Puffing of chapatti for a temperature of 280-320° C. for a time period of 10-30 sec
vii. Cooling and packing of chapatis

In an embodiment of the present invention commercial whole-wheat flour can be used having total ash 1.6%, protein content 10.0%, ether extractable (fat) 2.0% and damaged starch 16.0%.

The weight of the ingredients in grams used is

| Material | Wt | |
|---|---|---|
| Whole wheat flour | 90-110 | |
| Improver premix | 0.5-1.5 | |
| Water | 65-75 | |
| Total dry matter | 80-100 | |
| Moisture in chapati | 34.3-42.9 | |
| (30 g/70 g dry matter) | | |
| Total weight | 114.3-142.9 | |
| Production loss (1.0%) | 1.14-10.43 | |
| Yield of chapati per 100 kg | 113.16-141.47 | kg |
| of whole wheat flour | | |

In yet another embodiment whole wheat flour, improver premix and water may be mixed to get chapati dough.

In yet another embodiment improver premix may contain weighed proportions of ascorbic acid (50-150 parts), sodium stearoyl lactylate (250-750 parts) and guar gum (250-750 parts).

In yet another embodiment 100 parts of whole wheat flour may be blended with 0.5-1.5 parts of improver premix

In yet another embodiment chapati may be prepared and stored in BOPP pouches The details of the different operations in the process of the present inventions are 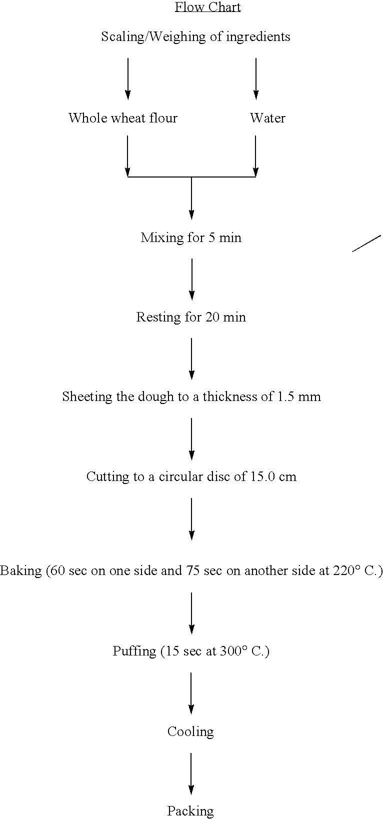
Sieving of Whole Wheat Flour and Scaling

Whole wheat flour is sieved to remove impurities. Whole wheat flour is weighed according to formulation.

Preparation of Dough

Whole wheat flour and water is mixed to form a homogeneous dough

Resting

The dough is rested for about 15-30 min

Sheeting and Cutting

The dough is sheeted to a thickness of 1.25 to 2.0 mm and cut to circular disc of 14-16 cm diameter.

Baking

The cut circular chapati dough sheets are baked at 200-240° C. for 60-90 sec on either side.

Puffing

Chapatis are puffed at 280-300° C. for 10 to 30 sec.

Cooling

Chapatis are cooled to room temperature.

Packaging

Four chapatis are packed in bioxially oriented polypropylene (BOPP) for futher analysis.

The following examples are given by way of illustration of the present invention and should not be construed to limit the scope of present invention.

### EXAMPLE 1

| Ingredients | Quantity (g) |
|---|---|
| Whole wheat flour | 100 |
| Water | 72 |
| Ascorbic acid | 0-0.02 |

Whole wheat flour and water are mixed, and the resultant dough is rested, sheeted, baked, puffed and cooled to room temperature. Four chapatis are packed in BOPP pouches for further evaluation. Chapatis were prepared with different levels of ascorbic and evaluated for appearance, pliability, tearing strength, aroma and eating quality as per the score sheet given in table 2. The chapatis were also objectively evaluated for shear value, which indicates the texture of chapatis. Improvement in chapati quality was observed till 0.01% of ascorbic acid in the formulation. Further increase in asborbic acid reduced pliability and eating quality. Chapatis became more chewy at higher level of ascorbic acid.

TABLE 1
Quality characteristics of chapatis

| Ascorbic | Appear- | Tearing | Pli- | Aro- | Eating | Overall | Shear |
|---|---|---|---|---|---|---|---|
| acid | ance | stength | ability | ma | Quality | Quality | value |
| (%) | (10) | (10) | (10) | (10) | (20) | (60) | (g) |

| | | | | | | | |
|---|---|---|---|---|---|---|---|
| 0 | 8.0 | 7.0 | 7.5 | 7.5 | 15.0 | 45.0 | 1420 |
| 0.005 | 8.0 | 7.5 | 8.0 | 7.5 | 16.0 | 47.0 | 1320 |
| 0.010 | 8.5 | 9.0 | 8.5 | 9.0 | 17.5 | 52.5 | 1080 |
| 0.015 | 8.5 | 9.0 | 8.0 | 8.0 | 16.5 | 50.0 | 1140 |
| 0.020 | 8.5 | 8.5 | 8.0 | 8.0 | 15.5 | 48.5 | 1220 |

TABLE 2
Reference score card for sensory evaluation of chapati
You receive set of coded samples
Score them for various characteristics given below
Maximum score is given in brackets you may also use quality description
given for each parameter
Quality characteristics

| Sl. | Sample | Appear- | Tearing | Pli- | Aro- | Eating | Overall |
|---|---|---|---|---|---|---|---|
| No. | code | ance | strength | ability | ma | quality | quality |
| | | (10) | (10) | (10) | (10) | (20) | (60) |

| Quality | | | | | | |
|---|---|---|---|---|---|---|
| descrip- | | Tearing | Pli- | | Eating | Overall |
| tion | Appearance | strength | ability | Aroma | quality | quality |
| Desir- | Smooth, | Resists | Pli- | Typical | Slightly | Highly |
| able | Light brown | tearing | able | wheaty | chewy | acceptable |
| | spots, | | | aroma | | |
| | uniformly | | | | | |
| | distributed, | | | | | |
| | moist | | | | | |
| Un- | Dark spots | Easy to | Brittle | Bland | Highly | Accept- |
| Desir- | rough | tear | flavour | or off | chewy | able Just |
| able | surface | | | flavor | or lacks | acceptable |
| | randomly | | | | chewi- | Unaccept- |
| | distrib- | | | | ness | able |
| | uted, dry | | | | | |

### EXAMPLE 2

| Ingredients | Quantity (g) |
|---|---|
| Whole wheat flour | 100 |
| Water | 72 |
| Sodium stearoyl lactylate | 0-1.0 |

Chapatis were prepared as in example 1 except for different levels of Sodium stearoyl lactylate (SSL) instead of ascorbic acid and evaluated for appearance, pliability, tearing strength, aroma and eating quality. The chapatis were also objectively evaluated for shear value. Improvement in chapati quality was observed till 0.5% of SSL in the formulation. Further increase in SSL affected the eating quality.

TABLE 3
Quality characteristics of chapatis

| Sodium | | | | | | | |
|---|---|---|---|---|---|---|---|
| stearoyl | Appear- | Tearing | Pli- | Aro- | Eating | Overall | Shear |
| lactylate | ance | stength | ability | ma | Quality | Quality | value |
| (%) | 10) | (10) | (10) | (10) | (20) | (60) | (g) |
| 0 | 8.0 | 7.0 | 7.5 | 7.5 | 15.0 | 45.0 | 1420 |
| 0.25 | 8.0 | 7.5 | 8.0 | 7.5 | 15.5 | 46.5 | 1280 |
| 0.50 | 8.5 | 9.0 | 8.5 | 9.0 | 18.0 | 53.0 | 960 |
| 0.75 | 8.5 | 9.0 | 8.0 | 8.0 | 17.5 | 51.0 | 940 |
| 1.00 | 8.5 | 8.5 | 8.0 | 8.0 | 16.0 | 49.0 | 960 |

### EXAMPLE 3

Chapatis are prepared as in example 1 except for different levels of guar gum instead of ascorbic acid and evaluated for appearance, pliability, tearing strength, aroma and eating quality. The chapatis were also objectively evaluated for shear value. Improvement in chapati quality was observed till 0.5% of guar gum in the formulation. Further increase in guar gum affected the eating quality.

TABLE 4
Quality characteristics of chapatis

| Guar | Appear- | Tearing | Pli- | Aro- | Eating | Overall | Shear |
|---|---|---|---|---|---|---|---|
| gum | ance | stength | ability | ma | Quality | Quality | value |
| (%) | 10) | (10) | (10) | (10) | (20) | (60) | (g) |
| 0 | 8.0 | 7.0 | 7.5 | 7.5 | 15.0 | 45.0 | 1420 |
| 0.25 | 8.0 | 7.5 | 8.0 | 7.5 | 15.5 | 46.5 | 1380 |
| 0.50 | 8.5 | 9.0 | 8.5 | 9.0 | 17.0 | 52.0 | 1090 |
| 0.75 | 8.5 | 9.0 | 8.0 | 8.0 | 17.0 | 50.5 | 980 |
| 1.00 | 8.5 | 8.5 | 8.0 | 8.0 | 15.5 | 48.5 | 960 |

### EXAMPLE 4

Blending of different additives was done to get the synergistic affect on chapati quality. 100 parts of ascorbic acid, 400 parts of sodium stearoyl lactylate and 500 parts of guar gum was blended to get the improver premix (blend A).

### EXAMPLE 5

Preparation of blend B was done by mixing 100 parts of whole wheat flour with 0.50 parts of blend A.

### EXAMPLE 6

Preparation of blend C was done by mixing 100 parts of whole wheat flour with 1.0 parts of blend A.

### EXAMPLE 7

Preparation of blend D was done by mixing 100 parts of whole wheat flour with 1.5 parts of blend A.

### EXAMPLE 8

Farinograph characteristics of blend B, C and D were determined according to standard AACC method, 2000 (Method 54-21). Water absorption increased with increasing proportion of improver premix. However, the increase was more upto 1.0% addition of improver premix in the formulation. Similarly dough stability also increased upto !% incorporation of improver premix. Quality number which indicates the strength of the dough increased with increase in improver premix.

TABLE 5
Effect of improver premix on farinograph characteristics of whole wheat
flour

| | Whole wheat | Blend | Blend | Blend |
|---|---|---|---|---|
| Characteristics | flour | B | C | D |
| Water absorption | 75.3 | 75.6 | 76.1 | 76.2 |
| (%) | | | | |
| Dough | 4.8 | 5.2 | 5.8 | 6.2 |
| Development time | | | | |
| (min) | | | | |
| Stability (min) | 1.8 | 2.7 | 3.2 | 3.3 |
| Mixing tolerance | 65 | 60 | 50 | 50 |
| index (BU) | | | | |
| Quality number | 59 | 70 | 87 | 90 |

### EXAMPLE 9

Extensograph characteristics of blend B, C and D were determined according to standard AACC method, 2000 (Method 54-10). Resistance to extension marginally increased with increase in improver premix. However, extensibility and area under the curve increased with increase in improver premix.

TABLE 6
Effect of improver premix on extensograph characteristics of whole
wheat flour

| | Whole wheat | Blend | Blend | Blend |
|---|---|---|---|---|
| Characteristics | flour | B | C | D |
| Resistance to | 320 | 330 | 330 | 320 |
| extension, R (BU) | | | | |
| Extensibility, E | 104.6 | 110 | 115 | 116 |
| (mm) | | | | |
| Ratio figure (R/E) | 3.07 | 3.00 | 2.87 | 2.76 |
| Area (cm²) | 48.3 | 50.3 | 52.0 | 51.0 |

### EXAMPLE 10

Chapati making characteristics of whole wheat flour with blend B, C and D were determined. Maximum improvement was observed with Blend C. It improved tearing properties, pliability and eating quality. The chapatis were soft as indicated by lower shear value. Overall quality score to chapatis made from whole wheat flour increased from 45 to 54.5 to chapatis made with blend C.

TABLE 7
Effect of improver premix on quality characteristics of chapatis

| | Appear- | Tearing | Pli- | Aro- | Eating | Overall | Shear |
|---|---|---|---|---|---|---|---|
| | ance | stength | ability | ma | Quality | Quality | value |
| | 10) | (10) | (10) | (10) | (20) | (60) | (g) |
| Whole | 8.0 | 7.0 | 7.5 | 7.5 | 15.0 | 45.0 | 1420 |
| wheat | | | | | | | |
| flour | | | | | | | |
| Blend B | 8.0 | 7.5 | 8.0 | 7.5 | 15.5 | 46.5 | 1380 |
| Blend C | 8.5 | 9.0 | 9.0 | 9.0 | 19.0 | 54.5 | 920 |
| Blend D | 8.5 | 9.0 | 9.0 | 8.0 | 17.0 | 51.0 | 900 |

### EXAMPLE 11

Chapatis were prepared with whole wheat flour and blend C and stored for 48 hours in BOPP (200 gauge) pouches for further evaluation. Chapatis stored well for 24 hours, and showed similar sensory characteristics. The chapatis are soft even upto 24 hours of storage as indicated by shear value. However, chapatis scored lower values for eating quality and overall quality when stored for 48 hours.

TABLE 8
Effect of storage period on quality characteristics of chapatis

| Storage | Appear- | Tearing | Pli- | Aro- | Eating | Overall | Shear |
|---|---|---|---|---|---|---|---|
| period | ance | stength | ability | ma | Quality | Quality | value |
| (hr) | 10) | (10) | (10) | (10) | (20) | (60) | (g) |
| 0 | 8.5 | 9.0 | 9.0 | 9.0 | 19.0 | 54.5 | 920 |
| 6 | 8.5 | 9.0 | 9.0 | 9.0 | 19.0 | 54.5 | 940 |
| 12 | 8.5 | 9.0 | 9.0 | 9.0 | 18.5 | 54.0 | 910 |
| 24 | 8.5 | 9.0 | 9.0 | 8.5 | 18.0 | 53.5 | 920 |
| 48 | 8.5 | 8.0 | 8.0 | 7.5 | 15.0 | 47.0 | 650 |

1. A process for preparing an improved quality chapatis having novel improver premix providing longer shelf-life to the chapatis, said process comprising steps of:
a) mixing an improver mix of concentration ranging between comprising of ascorbic acid, sodium stearoyl lactylate and guar gum with whole wheat flour,
b) adding desired quantity of water to the mixture of step (a) and mixing the same to obtain chapati dough,
c) ageing the chapati dough for a time period in the range of 20 to 30 minutes, and
d) sheeting and baking the aged chapati dough to obtain the chapatis.

2. A process as claimed in claim 1, wherein the whole wheat flour comprises total ash of concentration ranging between 1.6-1.8%, proteins of concentration ranging between 5 to 10%, Ether extractable fat of concentration ranging between 1.02-3.0%, and damaged starch of concentration ranging between 15-20%.

3. A process as claimed in claim 1, wherein the ratio of whole-wheat flour and improver premix is ranging between 60:1 to 220:1.

4. A process of claimed in claim 1, an improver premix comprising ascorbic acid, sodium stearoyl lactylate, and guar gum.

5. A process as claimed in claim 3, wherein the ratio of ascorbic acid to sodium stearoyl lactylate is ranging between 1:5 to 1:7.

6. A process as claimed in claim 3, wherein the ratio of ascorbic acid to guar gum is ranging between 1:5 to 1:7.

7. A process as claimed in claim 3, wherein the ratio of guar gum to sodium stearoyl lactylate is ranging between 1:2 to 2:1.

8. A process as claimed in claim 1, wherein 10-60 parts of water is added to the mixture of whole-wheat flour and improver mix.

9. A process as claimed in claim 1 wherein the aged chapati dough is sheeted to a thickness of about 1.25-2.0 cm and optionally cut into circles of diameter 14.0-16.0 cm.

10. A process as claimed in claim 1 wherein the sheeted chapati dough is baked at temperature ranging between about 210 to 230° C. for a time period of about 45-90 seconds.

11. A process as claimed in claim 1, wherein the sheeted chapati is baked on either side.

12. A process as claimed in claim 1, whereas the baked chapati is optionally puffed at a temperature ranging between about 290-3100° C. for a time period of about 15-20 seconds.

13. A process as claimed in claim 1, wherein the production loss is about 1.0% in weight.

14. An improver premix comprising ascorbic acid, sodium stearoyl lactylate, and guar gum.

15. An improved premix as claimed in claim 14, wherein the ratio of ascorbic acid to sodium stearoyl lactylate is ranging between 1:5 to 1:7.

16. An improved premix as claimed in claim 14, wherein the ratio of ascorbic acid to guar gum is ranging between 1:5 to 1:7.

17. An improved premix as claimed in claim 14, wherein the ratio of guar gum to sodium stearoyl lactylate is ranging between 1:2 to 2:1.

18. An improver premix as claimed in claim 14, wherein water absorption increases with the increase in the concentration of the improver premix.

19. An improver premix as claimed in claim 14, wherein dough development time increases by about 30% with the use of improver premix.

20. An improver premix as claimed in claim 14, wherein stability increases by about 85% with the use of improver premix.

21. An improver premix as claimed in claim 14, wherein quality number increases by about 55% with the use of improver premix.

22. An improver premix as claimed in claim 14, wherein extensibility increases by about 12% with the use of improver premix.

23. An improver premix as claimed in claim 14, wherein tearing strength increases by about 30% with the use of improver premix.

24. An improver premix as claimed in claim 14, wherein aroma increases by about 20% with the use of improver premix.

25. An improver premix as claimed in claim 14, wherein eating quality increases by about 27% with the use of improver premix.

26. An improver premix as claimed in claim 14, wherein overall quality increases by about 20% with the use of improver premix.

27. A chapati comprising of whole-wheat flour, improver premix, and water.

28. A chapati as claimed in claim 27, wherein improver premix comprises ascorbic acid, sodium stearoyl lactylate, and guar gum.

29. A chapati as claimed in claim 27, wherein the ratio of whole-wheat flour and improver premix is ranging between 60:1 to 220:1.

30. A chapati as claimed in claims 27, wherein increase in ascorbic acid reduces pliability and eating quality of chapati.

31. A chapati as claimed in claims 27, wherein chapati becomes more chewy with the increase with the concentration of ascorbic acid.

32. A chapati as claimed in claim 27, wherein water absorption increases with the increase in the concentration of the improver premix.

33. A chapati as claimed in claim 27, wherein dough development time increases by about 30% with the use of improver premix.

34. A chapati as claimed in claim 27, wherein stability increases by about 85% with the use of improver premix.

35. A chapati as claimed in claim 27, wherein quality number increases by about 55% with the use of improver premix.

36. A chapati as claimed in claim 27, wherein extensibility increases by about 12% with the use of improver premix.

37. A chapati as claimed in claim 27, wherein tearing strength increases by about 30% with the use of improver premix.

38. A chapati as claimed in claim 27, wherein aroma increases by about 20% with the use of improver premix.

39. A chapati as claimed in claim 27, wherein eating quality increases by about 27% with the use of improver premix.

40. A chapati as claimed in claim 27, wherein overall quality increases by about 20% with the use of improver premix.

41. A chapati as claimed in claim 27, wherein the storage period of the chapati with good quality nutrients is about 24 hours.

42. A chapati as claimed in claim 27, wherein the ratio of ascorbic acid to sodium stearoyl lactylate is ranging between 1:5 to 1:7.

43. A chapati as claimed in claim 27, wherein the ratio of ascorbic acid to guar gum is ranging between 1:5 to 1:7.

44. A chapati as claimed in claim 27, wherein the ratio of guar gum to sodium stearoyl lactylate is ranging between 1:2 to 2:1.
